(19) United States
(12) Patent Application Publication
(10) Pub. No.: US 2004/0256211 A1
(43) Pub. Date: Dec. 23, 2004

(54) Resilient switch contact for a key switch device

(75) Inventor: Wei-Chen Chen, Taipei (TW)

Correspondence Address: Paul D. Greeley Esq., Ohlandt, Greeley, Ruggiero & Perle, L.L.P., 10th Floor, One Landmark Square, Stamford, CT, 06901-2682, US

(73) Assignee: EMI STOP CORP.

(21) Appl. No.: 10/807,740

(22) Filed: Mar. 24, 2004

(30) Foreign Application Priority Data
Jun. 23, 2003 (TW) 092211417

(51) Int. Cl. H01H 5/18; H04Q 1/00

(52) U.S. Cl. 200/406

(57) ABSTRACT

A resilient switch contact for a key switch device includes a unitary conductive body that has a mounting end portion disposed in a first plane, a central operating portion disposed in a second plane spaced apart from the first plane in a first direction, an intermediate buffer portion interconnecting the mounting end portion to the central operating portion, and first and second support portions spaced apart from each other in a second direction transverse to the first direction and extending from the central operating portion in the first direction toward the first plane.

### CROSS-REFERENCE TO RELATED APPPLICATION

This application claims priority of Taiwanese Application No. 092211417, filed on Jun. 23, 2003.

### BACKGROUND OF THE INVENTION

1. Field of the Invention

The invention relates to a switch contact for a key switch device, more particularly to a unitary resilient switch contact for a key switch device.

2. Description of the Related Art

Referring to FIG. 1, a conventional key switch device 9 found in keypads of conventional portable electronic devices is shown to include a circuit board 8, a plastic biasing piece 91, a dielectric cover plate 92, and a key cap 93. The circuit board 8 is formed with a pair of electrical contacts 81 spaced apart from each other. The dielectric cover plate 92 is mounted on the circuit board 8, and cooperates with the circuit board 8 so as to confine a receiving space 921 that accommodates the electrical contacts 81. The plastic biasing piece 91 has first and second end portions 912 clamped between the circuit board 8 and the dielectric cover plate 92 and spaced apart from each other with the electrical contacts 81 disposed therebetween, and a curved intermediate biasing portion 913, which is inverted U-shaped, interconnecting the first and second mounting end portions 912, received and positioned in the receiving space 921, and spaced apart from the circuit board 8. A conductive portion 911 is mounted on the intermediate biasing portion 913, and is disposed above and is registered with the electrical contacts 81. The key cap 93 is mounted on the dielectric cover plate 92.

When the key cap 93 is pressed, the intermediate biasing portion 913 of the plastic biasing piece 91 is urged toward the circuit board 81 so as to drive movement of the conductive portion 911 from a normal position, where the conductive portion 911 is spaced apart from the electrical contacts 81, to a bridging position, where the conductive portion 911 contacts electrically the electrical contacts 81. Thereafter, when the key cap 93 is released, the intermediate biasing portion 913 of the plastic biasing piece 91 provides a restoring force to move the conductive portion 911 from the bridging position back to the normal position.

Due to its complicated construction, the conventional key switch device 9 is usually assembled manually. As such, the conventional key switch device 9 incurs relatively high production costs.

### SUMMARY OF THE INVENTION

Therefore, the object of the present invention is to provide a unitary resilient switch contact for a key switch device that is relatively inexpensive to produce.

According to one aspect of the present invention, there is provided a resilient switch contact for a key switch device. The resilient switch contact comprises a unitary conductive body having:

a mounting end portion disposed in a first plane;

a central operating portion disposed in a second plane spaced apart from the first plane in a first direction;

an intermediate buffer portion interconnecting the mounting end portion to the central operating portion; and

first and second support portions spaced apart from each other in a second direction transverse to the first direction and extending from the central operating portion in the first direction toward the first plane.

According to another aspect of the present invention, a key switch device comprises:

a circuit board formed with an electrical contact unit; and

a unitary conductive body having

a mounting end portion mounted on the circuit board,

a central operating portion spaced apart from the electrical contact unit of the circuit board in a first direction,

an intermediate buffer portion interconnecting the mounting end portion to the central operating portion, and

first and second support portions spaced apart from each other in a second direction transverse to the first direction and extending from the central operating portion in the first direction toward the circuit board.

The central operating portion is operable so as to move from a normal position, where the central operating portion is spaced apart from the electrical contact unit, to a pressed position, where the central operating portion, the intermediate buffer portion and the first and second support portions deform and where the central operating portion contacts electrically the electrical contact unit.

The intermediate buffer portion and the first and second support portions provide a restoring force to move the central operating portion from the pressed position back to the normal position.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary schematic sectional view of a conventional key switch device;

FIG. 2 is a fragmentary, partly exploded perspective view showing the first preferred embodiment of a key switch device according to the present invention;

FIG. 3 is a fragmentary schematic side view showing a unitary conductive body of the first preferred embodiment in a normal state;

FIG. 4 is a fragmentary schematic side view similar to FIG. 3, but showing the unitary conductive body in a pressed state;

FIG. 5 is a fragmentary, partly exploded perspective view showing the second preferred embodiment of a key switch device according to the present invention;

FIG. 6 is a perspective view showing a unitary conductive body of the third preferred embodiment of a key switch device according to the present invention;

FIG. 7 is a fragmentary schematic side view showing the third preferred embodiment when the unitary conductive body is in a pressed state;

FIG. 8 is a perspective view showing a unitary conductive body of the fourth preferred embodiment of a key switch device according to the present invention;

FIG. 9 is a perspective view showing a unitary conductive body of the fifth preferred embodiment of a key switch device according to the present invention; and

FIG. 10 is a perspective view showing a unitary conductive body of the sixth preferred embodiment of a key switch device according to the present invention.

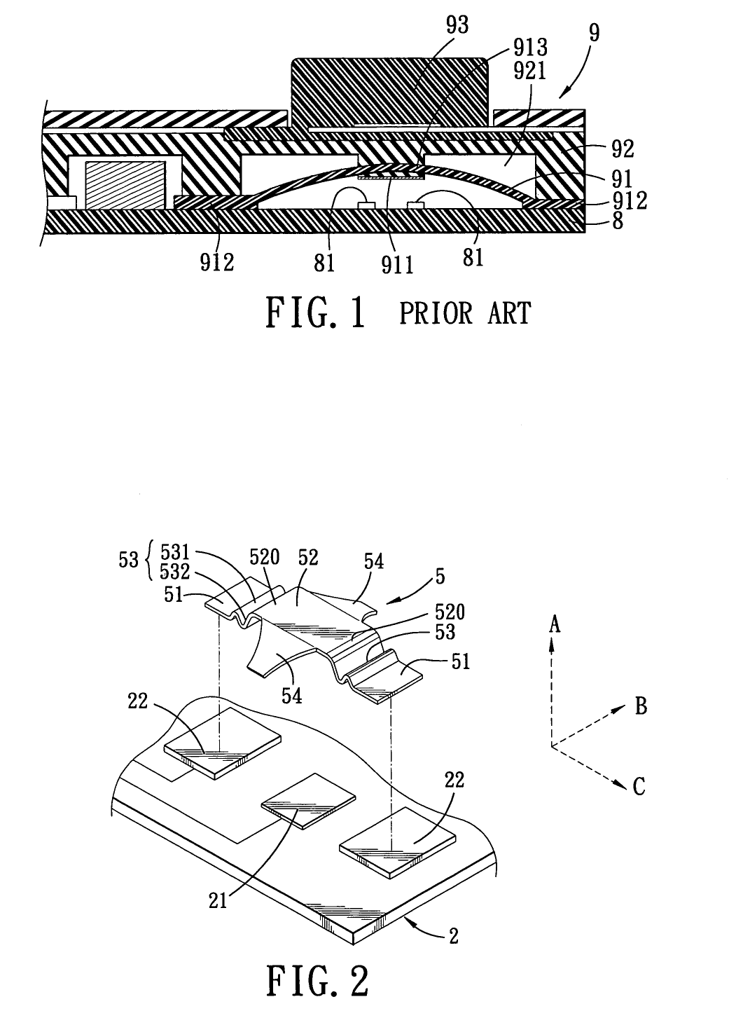

### DETAILED DESCRIPTION OF THE PREFERRED EMBODIMENTS

Before the present invention is described in greater detail, it should be noted that like elements are denoted by the same reference numerals throughout the disclosure.

Referring to FIGS. 2 to 4, the first preferred embodiment of a key switch device according to the present invention is shown to include a circuit board 2 and a unitary conductive body 5.

The circuit board 2 is formed with an electrical contact unit 21. In this embodiment, the circuit board 2 is further formed with a pair of solder pads 22 spaced apart from each other in a longitudinal direction (C)

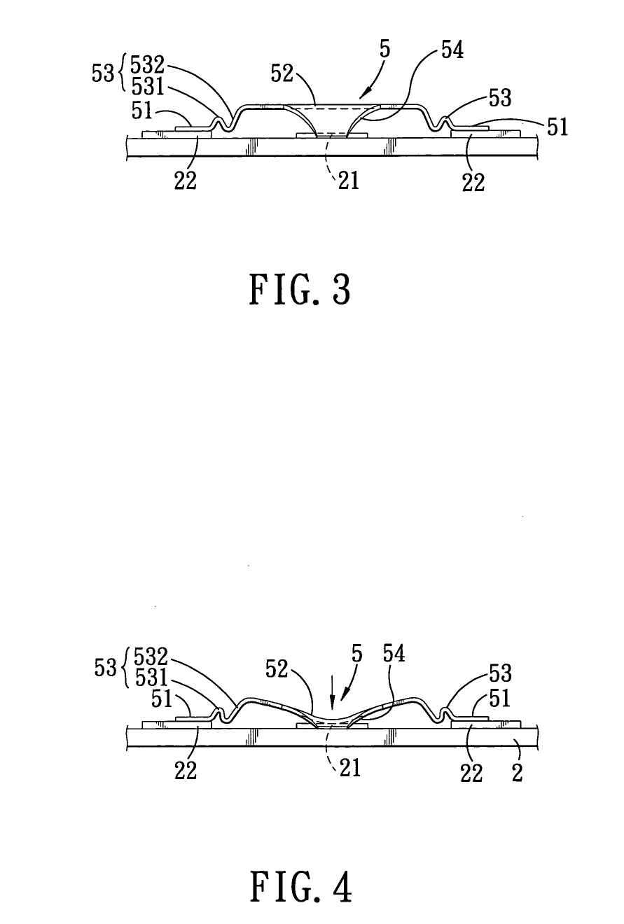

In this embodiment, the unitary conductive body 5 has first and second mounting end portions 51, a central operating portion 52, first and second intermediate buffer portions 53, and first and second support portions 54. The first and second mounting end portions 51 are spaced apart from each other in the longitudinal direction (C), and are mounted respectively on the solder pads 22 on the circuit board 2 by surface mounting such that the electrical contact unit 21 is disposed therebetween, as best shown in FIG. 3. The central operating portion 52 is disposed between the first and second mounting end portions 51, and is spaced apart from the first and second mounting end portions 51 in a first direction (A) transverse to the longitudinal direction (C). The central operating portion 52 has two ends 520 opposite to each other in the longitudinal direction (C). Each of the first and second intermediate buffer portions 53 interconnects a respective one of the first and second mounting end portions 51 to a respective one of the ends 520 of the central operating portion 52. In this embodiment, each of the first and second intermediate buffer portions 53 includes a bend section 531 extending from the respective one of the first and second mounting end portions 51, and a linear extension section 532 extending from the bend section 531 to the respective one of the ends 520 of the central operating portion 52. Preferably, the bend section 531 is inverted U-shaped, as best shown in FIG. 3. The first and second support portions 54 are spaced apart from each other in a second direction (B) transverse to the longitudinal direction and the first direction, and extend from the central operating portion 52 in the first direction (A) toward the circuit board 2. In this embodiment, the first and second support portions 54 extend inclinedly from the central operating portion 52 and away from each other, and have distal ends that are in contact with the circuit board 2.

The central operating portion 52 is operable so as to move from a normal position, where the central operating portion 52 is spaced apart from the electrical contact unit 21, as shown in FIG. 3, to a pressed position, where the central operating portion 52, the first and second intermediate buffer portions 53, and the first and second support portions 54 deform and where the central operating portion 52 contacts electrically the electrical contact unit 21, as best shown in FIG. 4. In this embodiment, when the central operating portion 52 is in the pressed position, the central operating portion 52 connects electrically the electrical contact unit 21 to the solder pads 22.

The first and second intermediate buffer portions 53 and the first and second support portions 54 cooperate to provide a restoring force for moving the central operating portion 52 from the pressed position back to the normal position.

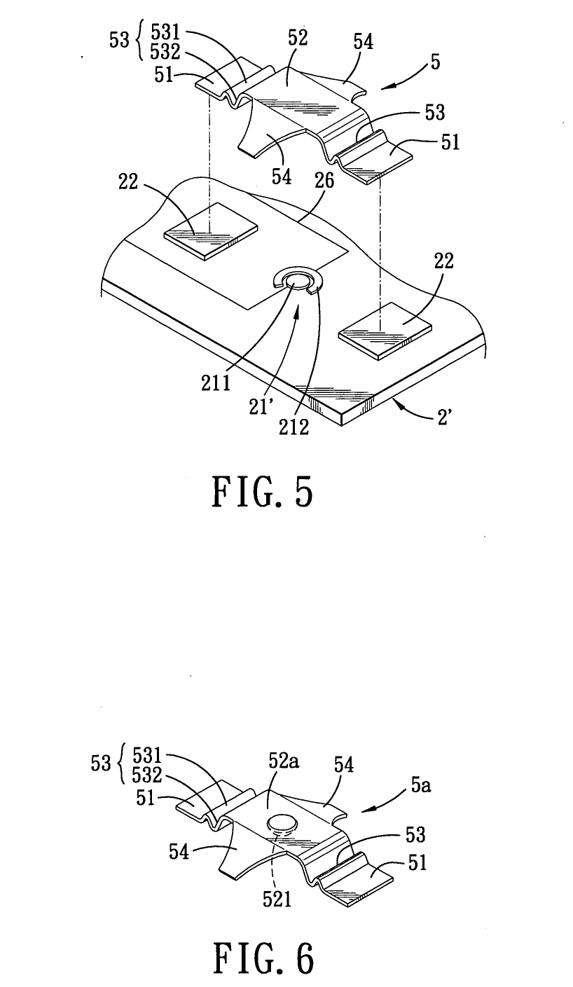

FIG. 5 illustrates the second preferred embodiment of a key switch device according to this invention, which is a modification of the first preferred embodiment. Unlike the previous embodiment, the electrical contact unit 21′ on the circuit board 2′ includes a pair of electrical contacts 211, 212 spaced apart from each other. The central operating portion 52 interconnects electrically the electrical contacts 211, 212 of the electrical contact unit 21′ when the central operating portion 52 is in the pressed position.

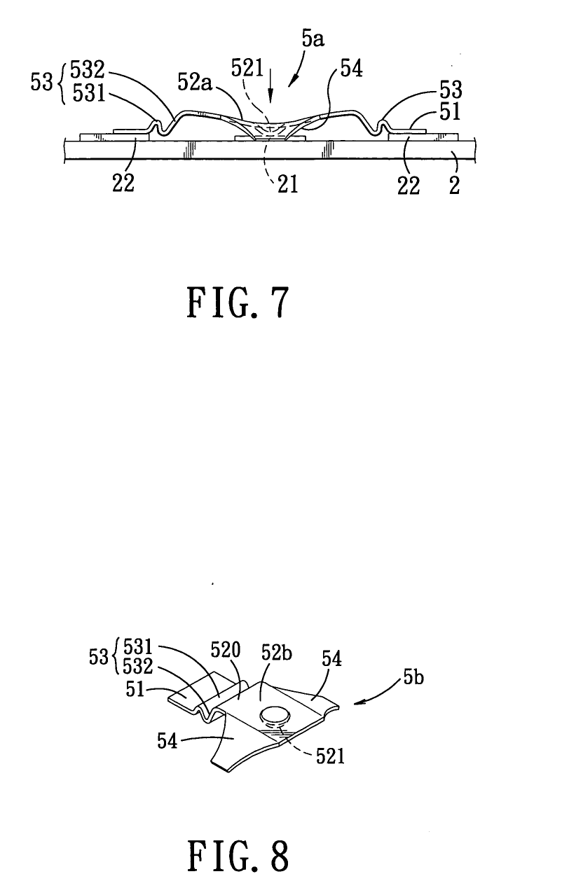

FIGS. 6 and 7 illustrate the third preferred embodiment of a key switch device according to this invention, which is a modification of the first preferred embodiment. In this embodiment, the central operating portion (52a) of the unitary conductive body (5a) is formed with a projection 521 that protrudes in the first direction (A) toward the circuit board 2 and that contacts electrically the electrical contact unit 21 when the central operating portion (52a) is in the pressed position.

FIG. 8 illustrates a unitary conductive body (5b) of the fourth preferred embodiment of a key switch device according to this invention, which is a modification of the third preferred embodiment. Unlike the embodiment of FIG. 6, the unitary conductive body (5b) only has one mounting end portion 51 to be mounted on a corresponding solder pad on the circuit board (not shown), and one intermediate buffer portion 53 that interconnects the mounting end portion 51 and one of the ends 520 of the central operating portion (52b).

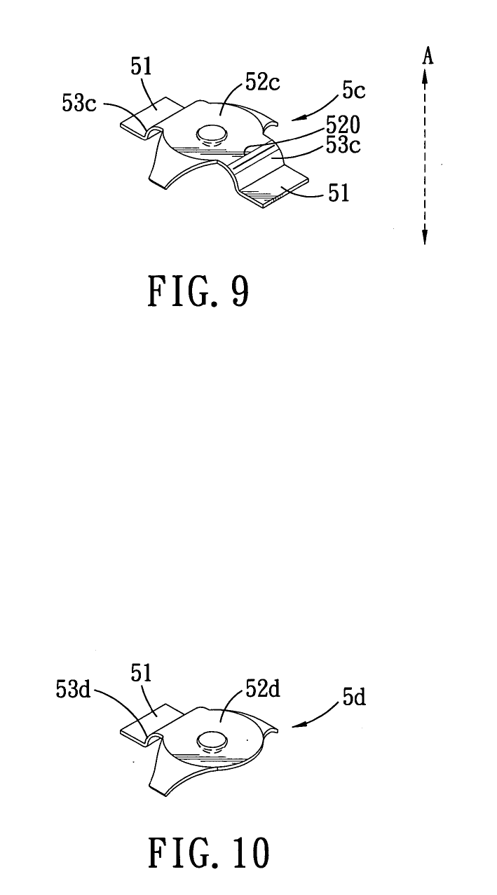

FIG. 9 illustrates a unitary conductive body (5c) of the fifth preferred embodiment of a key switch device according to this invention, which is a modification of the third preferred embodiment. Unlike the embodiment of FIG. 6, each of the first and second intermediate buffer portions (53c) of the unitary conductive body (5c) includes a curved section extending from the respective one of the first and second mounting end portions 51 in the first direction (A) toward the respective one of the ends 520 of the central operating portion (52c).

FIG. 10 illustrates a unitary conductive body (5d) of the sixth preferred embodiment of a key switch device according to this invention, which is a modification of the fifth preferred embodiment. Unlike the embodiment of FIG. 9, the unitary conductive body (5d) only has one mounting end portion 51 to be mounted on a corresponding solder pad on the circuit board (not shown), and one intermediate buffer portion (53d) that interconnects the mounting end portion 51 and one end 520 of the central operating portion (52d).

To sum up, since the unitary conductive body 5, (5a), (5b), (5c), (5d), which serves as a switch contact, is formed by punching, the drawbacks attributed to the complicated construction of the aforementioned conventional key switch device can be overcome. Furthermore, since the mounting end portions 51 can be mounted accurately and automatically on the circuit board 2, 2′ by surface mounting, assembly efficiency is enhanced. Moreover, the key switch device of this invention has a smaller profile as compared to the prior art.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A resilient switch contact comprising a unitary conductive body having:
a mounting end portion disposed in a first plane;
a central operating portion disposed in a second plane spaced apart from the first plane in a first direction;
an intermediate buffer portion interconnecting said mounting end portion to said central operating portion; and
first and second support portions spaced apart from each other in a second direction transverse to the first direction and extending from said central operating portion in the first direction toward the first plane.

2. The resilient switch contact as claimed in claim 1, wherein said intermediate buffer portion includes a bend section extending from said mounting end portion, and a linear extension section extending from said bend section to said central operating portion.

3. The resilient switch contact as claimed in claim 2, wherein said bend section is inverted U-shaped.

4. The resilient switch contact as claimed in claim 1, wherein said intermediate buffer portion includes a curved section extending from said mounting end portion in the first direction toward said central operating portion.

5. The resilient switch contact as claimed in claim 1, wherein said central operating portion is formed with a projection that protrudes in the first direction toward the first plane.

6. The resilient switch contact as claimed in claim 1, wherein said first and second support portions extend inclinedly from said central operating portion and away from each other.

7. A key switch device comprising:
a circuit board formed with an electrical contact unit; and
a unitary conductive body having
a mounting end portion mounted on said circuit board,
a central operating portion spaced apart from said electrical contact unit of said circuit board in a first direction,
an intermediate buffer portion interconnecting said mounting end portion to said central operating portion, and
first and second support portions spaced apart from each other in a second direction transverse to the first direction and extending from said central operating portion in the first direction toward said circuit board,
said central operating portion being operable so as to move from a normal position, where said central operating portion is spaced apart from said electrical contact unit, to a pressed position, where said central operating portion, said intermediate buffer portion and said first and second support portions deform and where said central operating portion contacts electrically said electrical contact unit,
said intermediate buffer portion and said first and second support portions providing a restoring force to move said central operating portion from the pressed position back to the normal position.

8. The key switch device as claimed in claim 7, wherein said intermediate buffer portion includes a bend section extending from said mounting end portion, and a linear extension section extending from said bend section to said central operating portion.

9. The key switch device as claimed in claim 8, wherein said bend section is inverted U-shaped.

10. The key switch device as claimed in claim 7, wherein said intermediate buffer portion includes a curved section extending from said mounting end portion in the first direction toward said central operating portion.

11. The key switch device as claimed in claim 7, wherein said central operating portion is formed with a projection that protrudes in the first direction toward said circuit board and that contacts electrically said electrical contact unit when said central operating portion is in the pressed position.

12. The key switch device as claimed in claim 7, wherein said first and second support portions extend inclinedly from said central operating portion and away from each other, and have distal ends that are in contact with said circuit board.

13. The key switch device as claimed in claim 7, wherein said circuit board is further formed with a solder pad for mounting said mounting end portion of said conductive body thereon, said central operating portion connecting electrically said electrical contact unit to said solder pad when said central operating portion is in the pressed position.

14. The key switch device as claimed in claim 7, wherein said electrical contact unit includes a pair of electrical contacts spaced apart from each other, said central operating portion interconnecting electrically said electrical contacts of said electrical contact unit when said central operating portion is in the pressed position.
